(19) United States
(12) Patent Application Publication
(10) Pub. No.: US 2006/0242473 A1
(43) Pub. Date: Oct. 26, 2006

(54) Phase optimization for data communication between plesiochronous time domains

(76) Inventors: Mark A. Wahl, Loveland, CO (US); Robert H. Miller JR., Loveland, CO (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/100,773

(22) Filed: Apr. 7, 2005

(51) Int. Cl. G11B 20/20; G06K 5/04; G11B 5/00

(52) U.S. Cl. 714/700

(57) ABSTRACT

A method and apparatus for optimizing data transfer between launch and capture domains driven by plesiochronous launch and capture clocks transmits a beacon of representational data from the launch domain to the capture domain and captures the beacon in the capture domain using the capture clock. The captured beacon is monitored for an anomaly. If an anomaly is not detected, a phase of the capture clock is adjusted and the beacon is transmitted, captured and monitored until an anomaly is detected. If an anomaly is detected, the phase of the capture clock is optimized relative to the captured beacon.

### BACKGROUND

In some integrated circuits (herein “IC”), separate clocks drive a core and an input/output (herein “I/O”) portion. The separate clocks in the two portions of the IC do not present an issue until the core and the I/O portions communicate either from the core to the I/O or the I/O to the core. Proper communication between the core and the I/O depends upon sufficient set up and hold times in order for the launched data to be reliably captured. In a specific example, the clocks are “plesiochronous” meaning that significant instants of each clock, such as a rising edge, occur at nominally the same rate, with any variation in rate being constrained within specified limits. The term “plesiochronous” as used herein further refers to the condition where the phase relationship between the two clocks is consistent, but unknown. Because the separate clocks have an indeterminate phase relationship, it is possible for the communication between the core and the I/O to violate the set up and hold time requirement. Even if the separate clocks are derivatives of the same source, propagation delays through IC transmission lines and logic provides sufficient uncertainty that the clocks responsible for data transfer are indeterminate with respect to the set up and hold requirements at the time of the data transfer. As clock speeds increase above 500 MHz, propagation delay and the variations in the propagation delay become a larger percentage of the clock period.

Prior art solutions to the challenges surrounding a plesiochronous and phase indeterminate phase relationship between two clocks include careful IC design to minimize or match propagation delay between the two communicating portions of the IC using phase locked loops and minimal clock signal transmission paths. As frequencies increase, however, this solution becomes restrictive and requires that potentially performance compromising trade-offs be made in other parts of the IC design. Another solution is multiplexing, buffering, and de-multiplexing two or more words at some multiple of the frequency (i.e. multiplex factor of 2) and then synchronously transferring the data across the core and I/O boundary at some fraction of the frequency (i.e. half of the frequency). In some applications, however, the latency involved with the multiplexing and buffering solution is unacceptable. Another solution is storing data into a FIFO buffer at the launching data rate and reading data out of the FIFO buffer at the capture data rate. Both launch and capture thereby synchronously communicate with the respective portion of the IC and provides reliable performance as long as the read and write pointers are sufficiently separated for proper function. This solution also introduces a latency that may be unacceptable in certain applications.

There is a need, therefore, to reliably transfer data across plesiochronous communication domains with minimum imposed latency.

### BRIEF DESCRIPTION OF THE DRAWINGS

An understanding of the present teachings can be gained from the following detailed description, taken in conjunction with the accompanying drawings of which:

FIG. 1 is a block diagram of a unidirectional embodiment according to the present teachings.

FIG. 2 is a timing diagram of example signals in the embodiment shown in FIG. 1.

FIG. 3 is a logic diagram of an embodiment of an anomaly detector according to the present teachings.

FIG. 4 is a logic diagram of an embodiment of a frequency divider with slip appropriate for use in an embodiment according to the present teachings.

FIG. 5 is a flow chart of a process performed by a phase calibration state machine according to the present teachings.

FIG. 6 is a block diagram of a bidirectional embodiment according to the present teachings.

FIG. 7 is a timing diagram of example signals in the embodiment shown in FIG. 6.

FIG. 8 is a flow chart of a bidirectional phase calibration process performed by the embodiment of a phase calibration state machine shown in FIG. 6 according to the present teachings.

FIG. 9 is a block diagram of an alternative unidirectional embodiment according to the present teachings.

### DETAILED DESCRIPTION

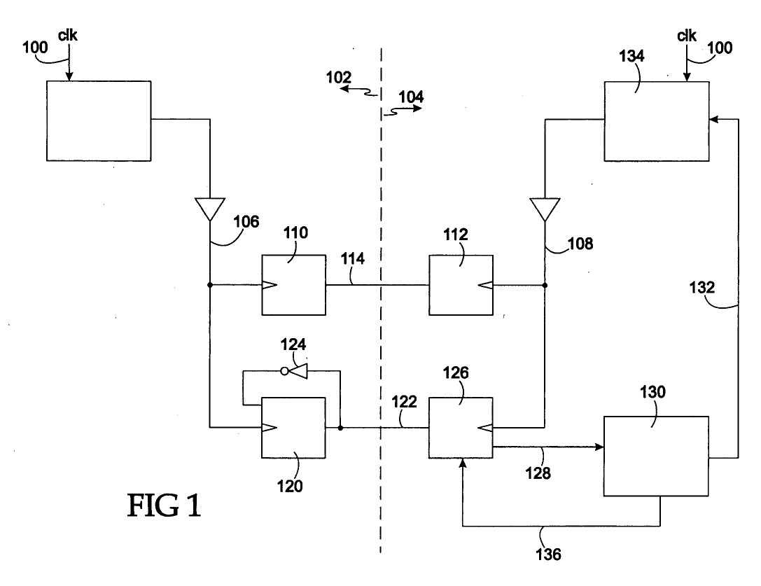

With specific reference to FIG. 1 of the drawings, there is shown a unidirectional embodiment according to the present teachings in which a source clock 100 drives a launch domain 102 and a capture domain 104. A launch clock 106 and a capture clock 108 are derivatives of the source clock 100 and drive data launch and capture operations, respectively, for separate and distinct portions of an IC. The launch and the capture domains 102, 104 communicate from a launch element 110 to a capture element 112. In a specific embodiment, the launch and capture elements 110, 112 are DQ flip-flops that are driven by the launch and capture clocks 106, 108, respectively. Because the launch and the capture clocks 106, 108 are derivatives of the same source clock 110, they are plesiochronous clocks. In the specific embodiment illustrated, the launch and capture clocks 106, 108 operate at the same frequency. Because of one or more unknown propagation delays between the source clock 100 and launch clock 106 relative to one or more unknown propagation delays between the source clock 100 and the capture clock 108, the plesiochronous launch and capture clocks 106, 108 have a fixed, but indeterminate phase relationship to each other. Reliable capture of data by the capture element 112 requires that data be presented to it some amount of set up time prior to a relevant edge of the capture clock and some amount of hold time that the data must be stable after the relevant edge of the capture clock 108. The relevant edge of the launch clock 106 stores data into the launch element 110 for presentation at a data communication line 114 at an output of the launch element 110. A relevant edge of the capture clock 108 stores data present on the communication line 114 at an input of the capture element 112. If the relevant edges of the launch and capture clocks 106, 108 are too closely aligned, a transition of the capture clock 108 may occur during a transition of data on the data communications line 114. Reliable communication between the launch and capture elements 110, 112 driven by the plesiochronous launch and capture clocks 106, 108, therefore, is dependent upon the phase relationship between the relevant edges of the launch and capture clocks 106, 108. The present teachings propose identifying a phase of the capture clock 108 where data communication from the launch domain 102 to the capture domain 104 is not reliable and then based upon a priori knowledge of the launch and capture clock frequencies, adjusting the phase of the capture clock 108 to optimize reliable capture of the data on the data communications line 114.

The launch clock 106 drives a beacon generator 120 that generates a beacon 200 having a known data pattern. In a preferred embodiment, the beacon generator 120 is co-located with the launch element 110 in the launch domain such that any phase difference between edges of the launch clock 106 as seen by the launch element 110 and edges of the launch clock 106 as seen by the beacon generator 120 is minimal. The beacon 200 provides representative data for presentation at a beacon communication line 122. In the embodiment illustrated in FIG. 1, an output of the beacon generator 120 is inverted 124 and presented at an input of the beacon generator 120 to generate a pattern of alternating 1's and 0's as the beacon 200. The beacon communication line 122 is connected to an anomaly detector 126. The capture clock 108 drives the anomaly detector 126. The anomaly detector 126 receives the beacon 200 and captures the beacon 200 as a captured beacon 204 at relevant edges of the capture clock 108. The anomaly detector 126 identifies an “anomaly” in the captured beacon 204 defined as a deviation from the expected pattern of the beacon 200, specifically alternating 1's and 0's in the illustrated embodiment. In a preferred embodiment, the anomaly detector 126 is co-located with the capture element 112 in the capture domain 104 such that any phase difference between edges of the capture clock 108 as seen by the capture element 112 and edges of the capture clock 108 as seen by the anomaly detector 126 is minimal. The beacon generator 120 provides representational data transmission from the launch domain 102 to the capture domain 104 and the anomaly detector 126 provides representational data reception by the capture domain 104 from the launch domain 102. The assumption, therefore, is that communication between the beacon generator 120 and the anomaly detector 126 over the beacon communication line 122 is representative of communication between the launch element 110 and the capture element 112 over the data communications line 114. A detected anomaly, therefore, is an indication that the phase relationship between the launch and capture clocks 106, 108 is such that the set up and hold time for the anomaly detector 126, and by assumption, the capture element 112, is violated for the existing phase relationship between the two clocks 106, 108.

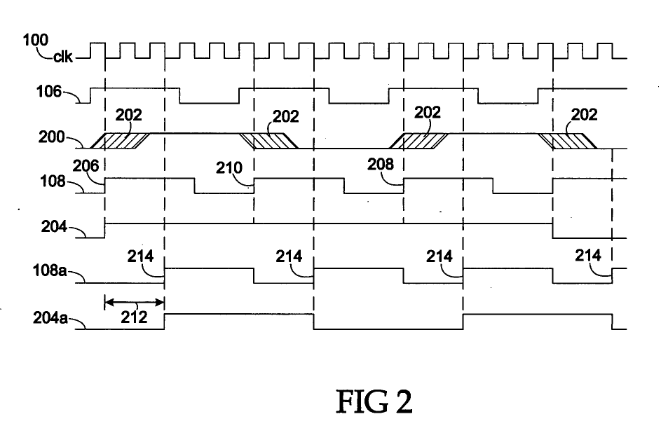

With specific reference to FIG. 2 of the drawings, there is shown a timing diagram showing an example of a possible timing relationship between the source clock 100, launch and capture clocks 106, 108 and the beacon 200. In the specific example shown in FIG. 2 of the drawings, the launch and capture clocks 106, 108 are derivatives of the source clock 100 divided by N, where N=5. The launch and the capture clocks 106, 108 as presented to the clock input to the launch and capture elements 110, 112, respectively, are shown as plesiochronous clocks with a constant relative phase. The phase difference shown in FIG. 2 is equal to one half of a cycle of the source clock 100 as an illustrative example. As one of ordinary skill in the art appreciates, even though the launch and capture clocks 106, 108 are derivatives of the same source clock 100, propagation and transmission line delays in the launch and capture domains 102, 104 between a source of the launch and capture clocks and the launch and capture elements, respectively, a phase difference between the clocks as seen by the launch and capture elements 110, 112 may by any gradient of the period of the launch/capture clocks 106, 108. The phase difference between the launch and capture clocks 106, 108, shown as one half of a cycle of the source clock 100, is for illustrative purposes only. The launch clock 106 drives the beacon generator 120 to generate the beacon 200. In a preferred embodiment, the beacon 200 is half the frequency of the launch clock 106. The beacon 200 is shown in FIG. 2 as having a transition time 202 responsive to a rising edge of the launch clock 106. The transition time represents the time required for the beacon generator 120 to store the data and present it at the output and the transmission time over the beacon communications line 122 for the data to be presented at an input of the anomaly detector 126. During the transition time 202, the logic value presented at the input of the anomaly detector 126 is indeterminate. As frequencies increase, the transition time 202 becomes a higher percentage of the period of the capture clock 108. As shown in FIG. 2 of the drawings, the captured beacon 204 may properly register a logic 1 at first 206 and third 208 relevant edges of the capture clock, respectively, but because the transition time of the beacon 200 from a logic 1 to a logic 0 violates the set-up and hold requirements in the anomaly detector 126 and by assumption, also violates the set-up and hold requirements of the capture element 112, the captured beacon 204 registers a logic 1 at a second relevant edge 210 of the capture clock 108 instead of the expected logic 0. Accordingly, the captured beacon 204 reflects at least three consecutive logic 1's. When the phase of the capture clock 108 where the capture of data is unreliable is identified, the capture clock 108 is then adjusted to optimize data capture.

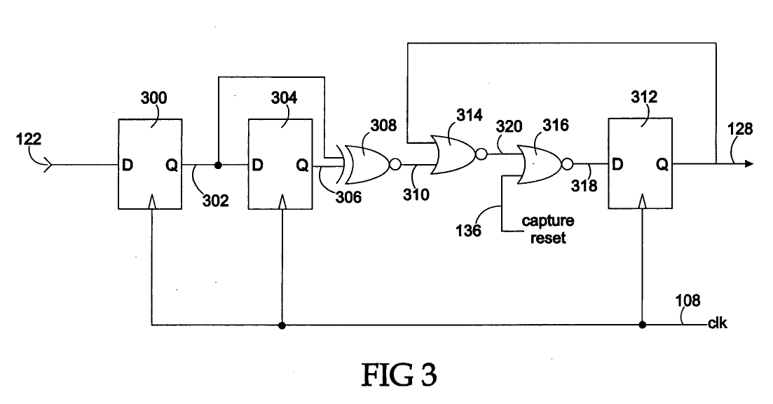

With specific reference to FIG. 3 of the drawings, there is shown a specific embodiment of the anomaly detector 126. A first beacon receive memory element 300 stores a logic value of the beacon as presented to the first beacon receive memory element 300 at an edge of the capture clock 108. An output of the first beacon receive memory element 302 is presented to an input of a second beacon receive memory element 304. The second beacon receive memory element 304 stores the logic value presented to it at a next edge of the capture clock 108. Also at the next edge of the capture clock 108, a new logic value is stored into the first beacon receive memory element 300. The first and second beacon receive memory elements 300, 304, therefore, store the last two consecutive logic values of the captured beacon 204 for each new transition of the capture clock 108. The two consecutive logic values of the captured beacon 204 as stored by the first and second beacon receive memory elements 300, 304, are presented to an exclusive NOR gate 308. An exclusive NOR gate output 310, therefore, is asserted only when both inputs are logic 1's or both inputs are logic 0's. In an alternate embodiment where the beacon 200 is a different data pattern than alternating 1's and 0's, one of ordinary skill in the art appreciates that logic that is different from the exclusive NOR gate is used to identify an anomaly in the captured beacon 204. The remainder of the circuit is a “sticky circuit with reset” and provides for a “sticky assertion” of an anomaly detected signal 128 and provision of a capture reset function for clearing the anomaly detected signal 128 when appropriate. A sticky memory element 312 accepts the exclusive NOR gate output 310 through a sticky NOR gate 314 and a capture reset NOR gate 316. The sticky memory element 312 stores the value of the exclusive NOR gate output 310 at an edge of the capture clock 108. The sticky NOR gate 314 accepts the exclusive NOR gate output 310 and a sticky memory element output 320. Accordingly, once the exclusive NOR gate output 310 is asserted, the anomaly detected signal 128 is also asserted and remains asserted until the sticky circuit 312, 314, 316 is cleared. The sticky NOR gate output 320 and the capture reset signal 136 are presented as inputs to the capture reset NOR gate 316. When the capture reset signal 136 is asserted, the capture reset NOR gate 316 presents a logic 0 to an input of the sticky memory element 312 for storage at the next edge of the capture clock 108, thereby de-asserting the anomaly detected signal 128 until the next anomaly occurs.

If the anomaly detector 126 identifies either two or more consecutive 1's or two or more consecutive 0's in the captured beacon 204, it asserts the anomaly detected signal 128. If the anomaly detector 126 identifies the expected pattern of alternating 1's and 0's, it does not assert the anomaly detected signal 128. A phase calibration state machine 130 is responsive to the anomaly detected signal 128. The state machine 130 identifies the phase of the capture clock 108 relative to the phase of the beacon 200 where the set up and hold time is violated by adjusting the phase of the capture clock 108 in successive increments until an anomaly in the captured beacon 204 is detected. The state machine 130 then adjusts the phase of the capture clock 108 to optimize the phase relationship of the capture clock 108 to the captured beacon 204(a) and the phase calibration process is complete.

The slip signal 132 causes the capture clock 108 to adjust its phase by lengthening or shortening a period of the capture clock 108 by a single cycle of the source clock 100. The state machine 130 issues successive identical phase adjustments until an anomaly is detected in the captured beacon 204. In a preferred embodiment, phase adjustments from lengthening the period of the capture clock 108 by a single cycle of the source clock 100. When the phase relationship between the launch and capture clocks 106, 108 is such that beacon communication is unreliable, it is inferred that the phase relationship between the capture clock 108 and the launch clock 106 is at a worst case for reliable communication. In fact, because the capture clock 108 is adjusted by single cycles of the source clock, the phase relationship between the launch and capture clocks 106, 108 is only known within a gradient equal to a single period of the source clock 100. When an anomaly is detected, therefore, the actual worst case is a phase relationship greater than zero relative to the last phase relationship and less than the present phase relationship. In other words, some movement toward an optimum phase relationship has already occurred by the time the anomaly is detected. When the anomaly in the beacon 200 is identified, the state machine 130 makes a final adjustment to the phase of the capture clock 108 to optimize reliable communication. In a unidirectional phase calibration embodiment, an optimized phase of the capture clock 108 is approximately 180 degrees out of phase relative to the phase of the capture clock 108 when the anomaly is detected.

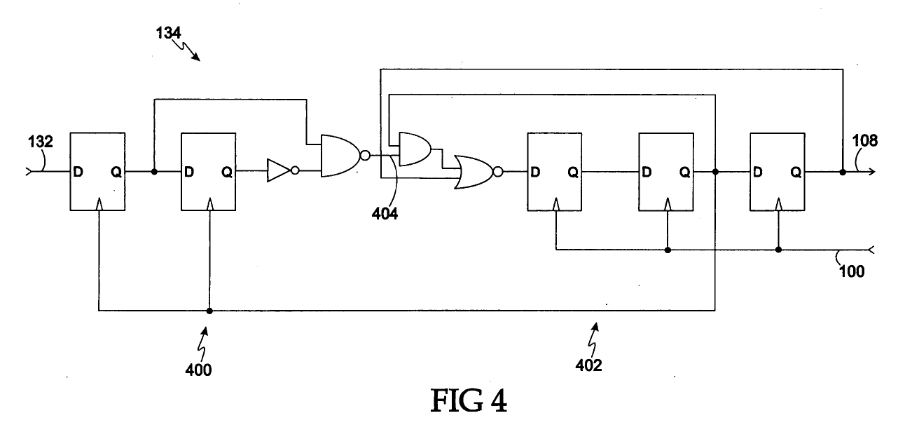

With specific reference to FIG. 4 of the drawings, there is shown a specific embodiment of the capture clock generator 134 as a divide by 5 frequency divider with slip. The divide by 5 frequency divider with slip includes a pulse generator 400 communicating with a frequency divider 402. The source clock 100 drives the frequency divider 402. The frequency divider 402 has two divide modes, a divide by 5 and a divide by 6, and is controlled by a divide mode signal 404. If the source clock 100 has a frequency of ƒ, therefore, the frequency divider 402 is able to provide a signal of frequency

$$\frac{f}{5}$$

and a signal of frequency

$$\frac{f}{6} .$$

In the specific embodiment shown in FIG. 4, the frequency divider 402 divides by 5 when the divide mode signal 404 is high and divides by 6 when the divide mode signal 404 is low. The divide mode signal 404 is normally high. When the pulse generator 400 accepts a slip signal 132, it issues a low going divide mode pulse signal 404 that causes the frequency divider 402 to divide by 6 for one cycle of the divided clock. The slip signal is limited in duration to effect only a single slip of the frequency divider 402. Accordingly, a result of assertion of the slip signal 132, the phase of the capture clock 108 is advanced in time by a single cycle of the source clock 100. Five successive advances results in a 360 degree phase shift of the capture clock 108. Additional details of a preferred embodiment of the frequency divider with slip is disclosed in co-owned and co-pending U.S. patent application Ser. No. __/______ entitled “Frequency Divider with Slip” filed Mar. 10, 2005 and invented by co-inventor of the present patent application, Robert Miller. The entirety of the “Frequency Divider with Slip” patent application is hereby incorporated by reference herein. Alternate apparatus' and methods to generate and adjust the phase of one plesiochronous clock relative to another are known and are not detailed in the present teachings. In the alternate apparatus' and methods, one plesiochronous clock may be the same or a different frequency relative to the other plesiochronous clock and different frequencies than those taught herein. Such alternate methods, clocks and frequencies are within the knowledge of one of ordinary skill and are suitable for use in an embodiment according to the present teachings.

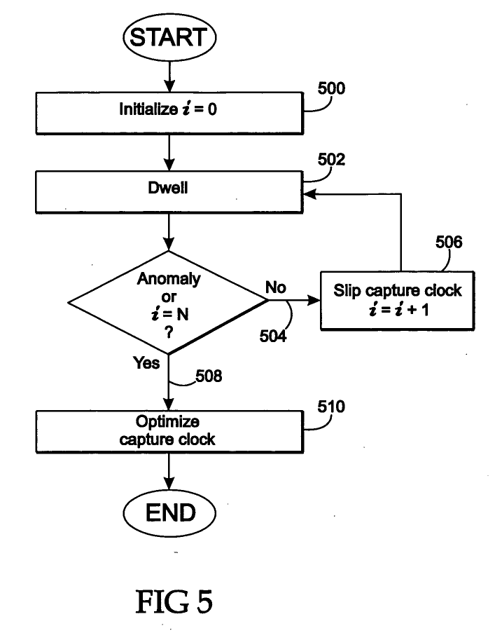

With specific reference to FIG. 5 of the drawings, there is shown a flow chart of a process performed by the phase calibration state machine 130. As one of ordinary skill in the art appreciates, the state machine 130 may be implemented as hardware, FPGA, or as firmware/software with an embedded processor. The structure of the state machine 130, therefore, is dictated by how it is implemented. In a preferred embodiment, the state machine 130 is implemented in a hardware logic circuit. The state machine 130 first initializes 500 the phase calibration process by asserting the capture reset signal 136 and setting a count variable to zero, i=0. The state machine 130 de-asserts the capture reset signal 136 and permits the anomaly detector 126 to dwell 502 for some period of time as it waits for an anomaly in the beacon 200. If an anomaly is not detected 504 after the dwell time, the state machine 130 asserts 506 the slip signal 132 to adjust the phase of capture clock 108 and increases the count variable by 1. The state machine 130 dwells 502 again under the phase adjusted capture clock 108 conditions and repeats the process of adjusting 506 the capture clock and dwelling 502 until an anomaly is detected 508 or all possible phase adjustments have been tested without detecting an anomaly. The number of possible phase adjustments is equal to the divide factor of the frequency divider 402 under normal operation. In the present example shown in FIG. 4, N=5. When an anomaly is detected, the state machine 130 optimizes 510 the phase of the capture clock 108 by adjusting the phase something less than or equal to a 180 degree phase shift. The general equation for an appropriate number of slips to achieve the approximate 180 degree phase shift is the integer value of the number of possible phase adjustments (N) divided in half. Specifically:

$$\# slips = INT ( \frac{N}{2} ) \qquad ( 1 )$$

With reference back to FIG. 2 of the drawings to illustrate the specific example, if an anomaly is detected for the phase of the capture clock shown as reference numeral 108 at edge 206, the state machine 130 adjusts the phase of the capture clock 108 in response to the detected anomaly by slipping the phase of the capture clock 108 an additional

$$INT ( \frac{5}{2} ) = 2$$

cycles 212 of the source clock 100. If N is an even number, the number of additional slips is equal to

$$\frac{N}{2} .$$

A new phase relationship results in an adjusted capture clock 108(a). As is apparent in the diagram of FIG. 2, the rising edges of the adjusted capture clock 108(a), shown as reference numeral 214, are positioned well within the range that the beacon 200 is considered reliable and stable. The beacon 200 as received by the capture element 112 driven by an optimized capture clock 108(a) is shown as reference numeral 204(a). Because the beacon generator 120 is substantially co-located with the launch element 110 and the anomaly detector 126 is substantially co-located with the capture element 112, and because the beacon generator 120 and anomaly detector 126 are driven by the launch and capture clocks 106, 108, respectively, the phase calibration of the relative phase between the launch and capture clocks 106, 108 is also deemed to be optimized for launch element 110 to capture element 112 data transmission. The phase calibration process as described by way of example with reference to FIGS. 1-5 optimizes the phase relationship between the launch and capture clocks 106, 108 to maximize the set up and hold time for data communication in one direction. In some cases, phase optimization in one direction is sufficient for reliable communication in both directions. In a unidirectional phase calibration embodiment of the present teachings, therefore, the phase calibration process is complete.

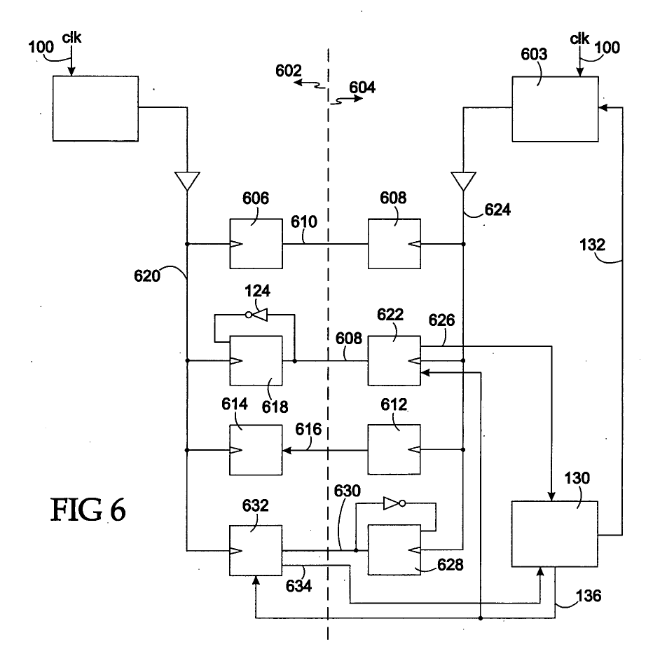

In some cases, it is desirable to optimize the phase relationship between the launch and capture clocks 106, 108 bi-directionally. The present teachings may be adapted to the bidirectional case by having two beacon generators and two anomaly detectors to detect the launch and capture condition that violate the set up and hold times for each direction of data communication. When the two phase locations are identified, the capture clock 108 is optimized by setting its phase in the middle of the largest gap between the two phase measurements. With specific reference to FIG. 6 of the drawings, there is shown an embodiment of the apparatus for optimizing the phase in the bidirectional case according to the present teachings in which the unidirectional case already described is extended. The terms “launch domain” and “capture domain” are used in describing the unidirectional case. In the bidirectional case, each domain has both launch and capture characteristics. Accordingly, for purposes of describing the bidirectional case, reference is made to a “core domain” 602 and an “I/O domain” 604 with bidirectional communication occurring therebetween. The core domain 602 is driven by core clock 620. The I/O domain 604 has I/O clock generator 603 generating I/O clock 624. The core clock 620 and I/O domain clock generator are driven off of the same source clock 100. In a specific embodiment, there is a core domain launch element 606 and an I/O domain capture element 608 with a first data communications line 610 presenting data from the core domain 602 to the I/O domain 604. Additionally, there is an I/O domain launch element 612 and a core domain capture element 614 with a second data communications line 616 presenting data from the I/O domain 604 to the core domain 602. One of ordinary skill in the art appreciates that no limitative interpretation is to be made as a result of the use of the core and I/O domain nomenclature, this nomenclature being used for purposes of describing bidirectional embodiments according to the present teachings by way of example. The core domain 602 has core beacon generator 618 generating a core beacon 700 and driven by the core clock 620. In a specific implementation, the core beacon 700 is a data pattern of alternating 1's and 0's. The core generator 618 presents the core beacon 700 onto core beacon transmission line 608 for presentation to I/O anomaly detector 622. The I/O anomaly detector 622 is driven by I/O clock 624. When the I/O anomaly detector 622 identifies an anomaly in the core beacon, see 704 for example, it asserts first anomaly detect signal 626. In response to the asserted first anomaly detect signal 626, the phase optimization state machine 130 records a first relative phase position of the I/O clock 624. The I/O domain 604 includes I/O beacon generator 628 generating I/O beacon 702 for transmission over I/O beacon communication line 630 for reception by core anomaly detector 632. The state machine 130 adjusts the phase of the I/O clock 624 by successive increments of a single cycle of the source clock 100, and thereby also the phase relationship of the I/O beacon 702 relative to the core clock 620, until a second anomaly is detected. When the core anomaly detector 632 identifies an anomaly in the I/O beacon 702, it asserts second anomaly detect signal 634. In response to the second anomaly detect signal 634, the phase calibration state machine 130 records a current relative phase position of the I/O clock 624. It is desired to place the phase of the I/O clock 624 relative to the core clock 620 that optimizes the set up and hold times for both directions of data communication. Accordingly, an optimized phase relationship is in the middle of the longest time that no anomaly is detected.

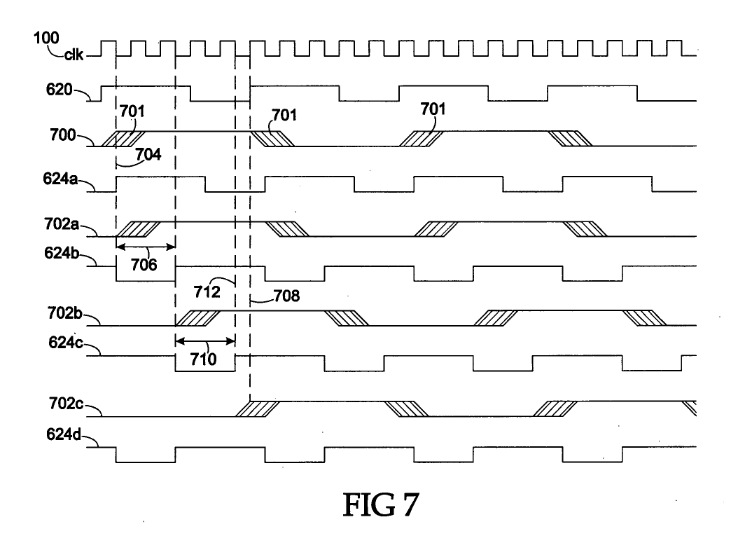

With specific reference to FIG. 7 of the drawings, there is shown example timing diagrams illustrating signals that are present in a process according to the present teachings of FIG. 6. FIG. 7 shows source clock 100 at frequency ƒ and core clock 620 at frequency

$$\frac{f}{N}$$

where N=5 as well as I/O clock 624 also at frequency

$$\frac{f}{N} .$$

In the illustrated embodiments, the frequency of the core clock 620 and the I/O clock 624 are the same. Alternative embodiments may include situations where the core clock 620 and the I/O clock 624 are different frequencies, but the frequency of the source clock 100 is an integer multiple of both the core and the I/O clocks 620, 624. The core beacon 700 is shown as a data pattern of alternating logic 1's and 0's. The core beacon 700 is generated using the core clock 620 and is shown as initiating transitions at rising edges of the core clock 620. Transition times plus set up and hold times for receiving logic is represented as indeterminate transition areas 701. The I/O clock 624 is shown in a first relative phase position at 624(a) as shifted in time one half of a source clock cycle relative to the core clock 620. This relationship is shown as an example and for purposes of clarity and description. One of ordinary skill in the art appreciates that plesiosynchronous clocks may have an infinite number of different phase relationships. If the core beacon 700 is clocked into the I/O anomaly detector 622 at rising edges of the I/O clock 624, the phase relationship of the core clock 620 to the I/O clock 624(a) shows that core beacon 700 is in its indeterminate state. Therefore, an anomaly will be detected at the relative phase of the two clocks 620 and 624(a). See reference numeral 704. The state machine 130 responds to assertion of the first anomaly detect signal 626, by storing a current phase position of the I/O clock 624. The state machine then adjusts the phase of the I/O clock in successive increments equal to a single cycle of the source clock 100. For each incremental phase change, the state machine 130 dwells and waits for a detected anomaly. Finding none, the state machine 130 makes a next incremental phase change. The I/O clock 624(b) represents the phase of the I/O clock 624 relative to the unadjusted core clock 620 after the state machine 130 has made two adjustments. The result of the two adjustments is an I/O clock 624(b) shifted relative to the original phase relationship of the I/O clock 624(a) by two periods of the source clock. See reference numeral 706. The timing diagram for the intermediate phase adjustment of one cycle is not shown for purposes of clarity. A first phase adjusted I/O beacon 702(b) is generated with the first phase adjusted I/O clock 624(b). At the phase relationship of the core clock 620 relative to the first phase adjusted I/O clock 624(b), the first phase adjusted I/O beacon 702(b) is well within the proper timing relationship so that rising edges of the core clock 620 properly register the data pattern of the I/O beacon 702(b). See reference numeral 708. Two more adjustments equal to a two cycles of the source clock 100 are made of the I/O clock 624 to arrive at a second phase adjusted I/O clock 624(c). See reference numeral 710. Second phase adjusted I/O beacon 702(c) is generated using second phase adjusted I/O clock 624(c). As can be seen from the timing diagram, rising edges of the core clock 620 occur at an indeterminate transition area of the second phase adjusted beacon 702(c). See reference numeral 708. The core anomaly detector 632, therefore, identifies an anomaly in the I/O beacon 702(c) and asserts the second anomaly detect signal 634. The state machine 130 responds to the asserted second anomaly detect signal 634 by storing a current phase of the I/O clock(c) relative to an original phase of the I/O clock(a). See reference numeral 712.

The first anomaly is detected at time 0 shown as timing location 704. The second anomaly is detected at time 4 shown as timing location 712. In the present example, there are 5 timing increments in a phase adjustment over a full cycle of the I/O clock 624. The first row of the following table represents repetitive timing increments of 0 through 4. The second row of the following table represents whether or not an anomaly is detected in either communication direction. Accordingly, the illustrated example of FIG. 6 results in the following:

TABLE 1

| | | | | | | | | | | | |
|---|---|---|---|---|---|---|---|---|---|---|---|
| 0 | 1 | 2 | 3 | 4 | 0 | 1 | 2 | 3 | 4 | 0 | 1 |
| 1 | 0 | 0 | 0 | 1 | 1 | 0 | 0 | 0 | 1 | 1 | 0 |

In most cases using high-speed clocks, the phase optimization state machine 130 for the bidirectional case will find at least one anomaly as the phase of the I/O clock 624 relative to the core clock 620 is adjusted over its period. If no anomaly is found, the phase relationship between the core and I/O clocks 620, 624 has no impact on data communications. If only one anomaly is found, the phase optimization process is the same as in the unidirectional case illustrated in FIG. 5 of the drawings. Specifically, the optimized adjustment of the phase of the I/O clock 624 is the integer portion of the result of half of N or

$$INT ( \frac{N}{2} )$$

from the initial phase position of the I/O clock 624. If two or more anomalies are found, it is most likely that there will be at most two groupings of anomalies that define two sections where anomalies are not detected. The phase optimization process determines a largest one of the two sections between the detected anomaly groupings and positions the phase of the I/O clock 624 in a center of the largest section. Based upon the data in Table 1, only two anomalies are found. A first anomaly (“a1”) in the example is detected at time 0, which represents an unadjusted phase relationship of the I/O clock 624. A second anomaly (“a2”) is detected at time 4, which represents the I/O clock 624 adjusted four cycles of the source clock 100 relative to the unadjusted phase relationship of the I/O clock 624. A first section between the detected anomalies is calculated as:
d1=a2−a1 (2)

In the example, therefore, d1=a2−a1=4. A second section between the detected anomalies is calculated as:
d2=(a1+N)−a2 (3)

In the example, d2=(a1+N)−a2=(0+5)−4=4−4=1. The largest s is determined to be d1=4. A center of the largest section is calculated to be c cycles from the phase position from which the section is calculated:

$$c = INT ( \frac{MAX ( d 1 , d 2 )}{2} ) \qquad ( 4 )$$

The state machine determines how many slips of the source clock 620 are appropriate in order to position the phase of the I/O clock 624 c cycles of the source clock from the phase position from which the section is calculated based upon a current phase position of the I/O clock 624. In the example, therefore,

$$c = INT ( \frac{MAX ( 4 , 1 )}{2} ) = INT ( \frac{4}{2} ) = 2.$$

If d1 is the largest section, an optimized phase relationship is c source clock cycles from a1 and if d2 is the largest section, the optimized phase relationship is c source clock cycles from a2. In the example, the largest section is d1=4 and the center of the largest section is c=2 source clock cycles from the a1 anomaly. Additionally, the current phase position of the I/O clock 624 is a2. Therefore, the optimized phase relationship of the I/O clock 624 relative to the core clock 620 is 2 source clock cycles from the original phase position of the I/O clock 624, which is shown as reference numeral 704 in the example. An optimized I/O clock 624 is shown in the illustration as I/O clock 624(d).

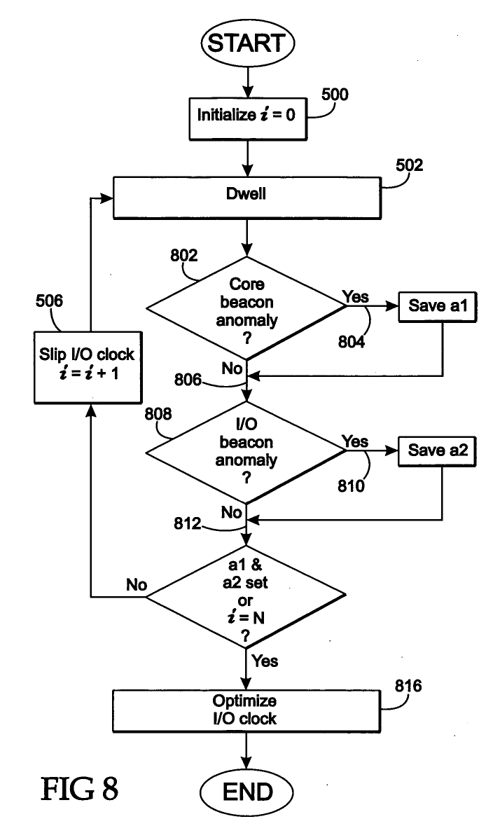

With specific reference to FIG. 8 of the drawings, there is shown a flow chart of a specific embodiment of a bidirectional phase optimization process according to the present teachings. The process shown in FIG. 8 is suitable for the state machine 130 shown in FIG. 7 of the drawings and is applicable to the situation where a maximum of 2 detected anomalies is expected, one for the core beacon 700 and one for the I/O beacon 702. The initialization step 500 is the same as that shown in the unidirectional embodiment where the capture reset signal 136 is asserted to reset the first and second anomaly detectors 622, 632 and the count variable is set to zero, i=0. The state machine 130 de-asserts the capture reset signal 136 and dwells 502 for some period of time as it waits for an anomaly to be detected in the core beacon 700 or in the I/O beacon 702. If 802 a core beacon anomaly is detected 804 for the first time, the current phase status of the I/O clock 624 is recorded as the first detected anomaly al. In the specific embodiment, the core beacon anomaly detector 622 is a “sticky detect” and remains asserted for the rest of the process. Accordingly, only the first assertion of the core beacon anomaly detected signal 626 is identified. If the core beacon anomaly is not detected 806, no action is taken and the process continues. The state machine 130 then determines 808 if any anomaly is detected in the I/O beacon 702. If an anomaly is detected 810 for the first time, the current phase status of the I/O clock is recorded as the second detected anomaly a2. In the specific embodiment, the anomaly beacon anomaly detector 632 is also a “sticky detect” and remains asserted for the rest of the process. Accordingly, only the first assertion of the I/O beacon anomaly detected signal 634 is identified. If no anomaly is detected 812, no action is taken. If a1 and a2 are set OR the count variable i is equal to the number of source clock 100 cycles in a single I/O clock 624 cycle, N, no more anomalies are expected and the process continues to the optimization 816 step. If al or a2 are not set and the count variable, i, is not equal to N, the state machine 130 asserts 506 the slip signal 132 to slip the I/O clock 624 by one cycle of the source clock 100, increases the count variable by 1, and the returns to the dwell 502 step with the adjusted I/O clock 624. The process repeats until both anomalies are recorded or the count variable is equal to N. When both anomalies are set or the count variable is equal to N, the state machine 130 optimizes 816 the phase of the I/O clock 624 relative to the core clock 620 by positioning the phase of the I/O clock 624 to be approximately 180 degrees from the detected anomaly if only one is found or centered in the largest difference between the detected anomalies if two anomalies are found.

In an alternate bi-directional embodiment where more than two anomalies may be detected as the phase of the I/O clock 624 is adjusted over the entire cycle of the core clock 620, the variables al and a2 are replaced with an anomaly array a(*) having N elements. Each element of the array represents time slip 0 through N−1 and is a logic 1 or logic 0 depending upon whether an anomaly is detected at respective time slips. As the state machine 130 identifies an anomaly, it stores a 1 in the proper array element and if no anomaly is detected, a 0 is stored. After each anomaly is detected, the state machine 130 asserts the capture reset signal 136. Calculations based upon data in the anomaly array to identify the largest of the two sections where no anomaly is detected are not detailed, but are within the capability of one of ordinary skill in the art. This alternative bi-directional embodiment is more precise, but takes more time to complete the optimization process. It is appropriate when the source clock 100 is in small enough increments relative to the set and hold times being identified in the communications system.

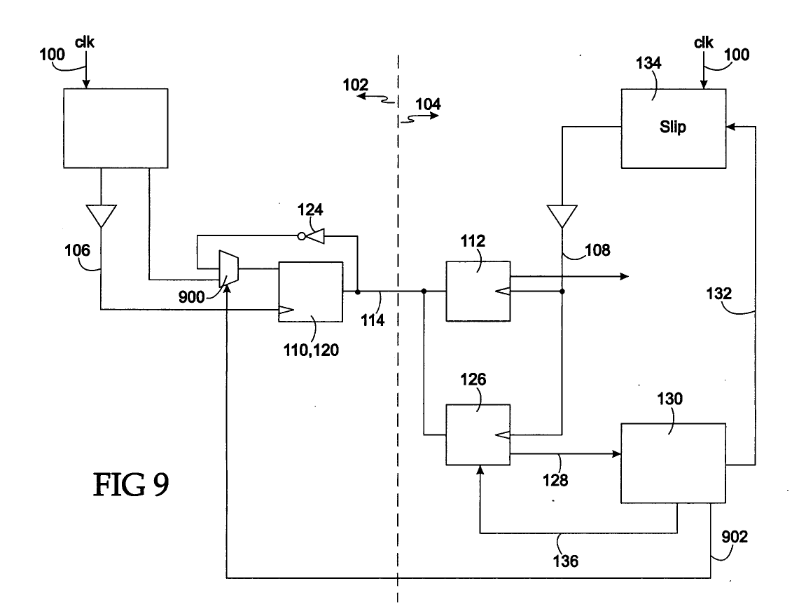

With specific reference to FIG. 9 of the drawings, another unidirectional embodiment according to the present teachings transmits the beacon over the data communications line 114 thereby obviating the dedicated beacon transmission line 122. One of ordinary skill in the art appreciates that the anomaly detector 126 communicates with the data communications line 114 through 2:1 multiplexer 900. The process performed by the state machine 130 is similar to embodiments disclosed herein. In the embodiment that shares the data communications line for functional data and the beacon 200, the state machine 130 asserts an optimized phase signal 902 for reception by the selection input of the multiplexer 900 after the optimization step to begin the normal data transmission function of the device. Advantageously, the beacon generator 120 is tightly coupled with the launch element 110. If the anomaly detector 126 is tightly coupled with the capture element 112 by being co-located, the phase optimization apparatus and process is highly representative of the timing of the functional data communication. Disadvantageously, the multiplexer 900 is disposed in the timing path of the data transmission thereby inserting undesirable latencies. The embodiment of FIG. 9 may be extended by one of ordinary skill in the art to the bi-directional case.

Another embodiment according to the present teachings one or both of the core anomaly detector 632 and the core beacon generator 618 are disposed in the I/O domain 604. Advantageously, most of the electronics for the phase optimization is disposed in only one of the domains 602, 604. From a product offering, a vendor of electronics in the I/O domain 604 need not affect the client design by requiring that electronics be present in the client's core domain 602. Disadvantageously, the beacon generator(s) and anomaly detector(s) are not as closely coupled to the data transmission and reception electronics to support the assumption that anomalies detected are representative of data transmission characteristics between the two domains. Accordingly, it is believed that the embodiment where the beacon generator(s) 120 and 618, 628 are co-located with the data transmission electronics 110 and 606, 612 and where the anomaly detector(s) 126 and 622, 632 are co-located with the data reception hardware is a more accurate embodiment for identifying anomalies in the data communication system between the two domains 602, 604.

Embodiments according to the present teachings are described by way of example to illustrate specific examples of that which are claimed. Alternative embodiments include those where the beacon is a repetitive data pattern other than the alternating 1's and 0's suggested herein. It is also possible for the launch and capture clocks 106, 108 to be different frequencies while still being plesiochronous and a derivative of the same source clock 100. In that case, the capture clock 108 is slipped over the entire period of the launch clock 106. Other embodiments and adaptations will occur to one of ordinary skill in the art given the present teachings and are considered within the scope of the appended claims.

Advantages: 1. minimum latency, 2. no need to force consistent prop delays for launch and capture domains, 3. optimized based upon existing circuit, 4.

Alternatives 1. beacon is other known patterns, 2. other designs for frequency divider with capability to make phase adjustments.

1. A method for optimizing data transfer between launch and capture domains driven by plesiochronous launch and capture clocks comprising the steps of:
Transmitting a beacon of representational data from the launch domain to the capture domain, the beacon generated in the launch domain and driven by the launch clock,
Capturing the beacon in the capture domain using the capture clock,
Monitoring the captured beacon for an anomaly,
If an anomaly is not detected, adjusting a phase of the capture clock, and repeating the steps of transmitting, capturing and monitoring until an anomaly is detected, and
If an anomaly is detected, optimizing the phase of the capture clock relative to the launch clock.

2. A method as recited in claim 1 wherein the step of optimizing comprises adjusting the phase of the capture clock to be approximately 180 degrees out of phase relative to the phase of the capture clock when the anomaly is identified in the captured beacon.

3. A method as recited in claim 1 and further comprising the steps of storing a first anomaly phase relationship based upon a first identified anomaly,
repeating the steps of transmitting, capturing and monitoring,
storing a second anomaly phase relationship based upon a second identified anomaly, and
optimizing the phase of the capture clock relative to the phase of the capture clock for the first and second anomaly phase relationships.

4. A method as recited in claim 3 wherein the step of optimizing comprises adjusting a phase relationship of the capture clock relative to the first and second anomaly phase relationships to maximize a difference between the first and second anomaly phase relationships.

5. A method as recited in claim 1 wherein the launch clock and capture clock have the same frequency and the frequency is a multiple of a source clock and wherein the step of adjusting comprises slipping the phase by at least one period of the source clock.

6. A method as recited in claim 5 wherein the frequency of the launch and capture clocks are 1/N^{th} the frequency of the source clock and wherein said step of optimizing comprises slipping a phase of the capture clock an integer value equal to or less than N/2 additional periods of the source clock.

7. A method as recited in claim 6 wherein N is an odd integer.

8. A method as recited in claim 1 wherein the beacon comprises a data stream of logic 1's and 0's and the anomaly comprises a data pattern of at least two logic values selected from the group consisting of 1's and 0's.

9. A method as recited in claim 8 wherein said beacon is half the frequency of the capture clock.

10. An apparatus for optimizing data transfer between launch and capture domains driven by plesiochronous launch and capture clocks comprising:
A beacon generator in a launch domain driven by the launch clock that generates a beacon,
An anomaly detector in a capture domain driven by the capture clock that registers the beacon as a captured beacon and indicates a detected anomaly in the captured beacon, and
A state machine responsive to the detected anomaly that adjusts the phase of the capture clock to optimize a relative phase between the launch clock and the captured beacon.

11. An apparatus as recited in claim 10 wherein the state machine adjusts the phase of the capture clock to be approximately 180 degrees out of phase relative to the phase of the capture clock when the anomaly is detected in the captured beacon.

12. An apparatus as recited in claim 10 the state machine responsive to first and second anomaly detectors and adjusts the phase of the capture clock to optimize the capture clock based upon first and second detected anomalies.

13. An apparatus as recited in claim 12 wherein the state machine adjusts the phase of the capture clock to maximize a difference between first and second detected anomalies.

14. An apparatus as recited in claim 10 wherein the launch and capture clocks have the same frequency and the frequency is a multiple of a source clock and the state machine adjusts the capture clock in increments equal to a period of the source clock.

15. An apparatus as recited in claim 14 wherein the frequency of the launch and capture clocks are 1/N^{th} the frequency of the source clock and wherein the state machine optimizes the capture clock by slipping a phase of the capture clock an integer value equal to or less than N/2 additional periods of the source clock relative to the phase of the capture clock when the anomaly is detected.

16. A method as recited in claim 15 wherein N is an odd integer.

17. A method as recited in claim 10 wherein the beacon comprises a data stream of logic 1's and 0's and the anomaly comprises a data pattern of at least two consecutive logic values selected from the group consisting of 1's and 0's.

18. A method as recited in claim 1 wherein the beacon is half the frequency of the capture clock.
